(19) United States
(12) Patent Application Publication
(10) Pub. No.: US 2013/0278164 A1
(43) Pub. Date: Oct. 24, 2013

(54) LIGHT FIXTURE REMOTE CONTROLLING SYSTEM

(71) Applicant: JUSTING TECHNOLOGY (TAIWAN) PTE LTD, Zhongli City (TW)

(72) Inventors: JIA QING SU, Zhongli City (TW); YUAN MING YU, Zhongli City (TW); TUNG JUNG CHAN, Zhongli City (TW); CHING MU CHEN, Zhongli City (TW); SHEN YAUR CHEN, Zhongli City (TW)

(21) Appl. No.: 13/855,898

(22) Filed: Apr. 3, 2013

(30) Foreign Application Priority Data
Apr. 5, 2012 (TW) 101112038

(51) Int. Cl. H05B 37/02

(52) U.S. Cl. CPC H05B 37/0245
USPC 315/201

(57) ABSTRACT

A light fixture remote controlling system comprises a remote host and at least one light fixture; wherein the remote host has a monitoring software, electrically connected with a first wireless transmitting/receiving module and a first power amplifying module; each light fixture is provided in the body thereof with an AC-DC converter for a connection with a power source, a photoelectric module, and a controlling circuit electrically connected between the AC-DC converter and the photoelectric module, respectively; wherein the controlling circuit is integrated with: a dimming module; a current/voltage stabilizing module; a second wireless transmitting/receiving module; a voltage/current detecting module; a second power amplifying module; and a signal processing module.

### BACKGROUND OF THE INVENTION

1. Field of the Invention

The present invention relates to a light fixture monitoring system, especially referring to a light fixture remote controlling system that receives the operation information of the light fixture through a wireless transmission mode, or transmits control signals to a light fixture.

2. Description of the Prior Art

The electric light today might be regarded as the most widely used photoelectric technology and also one of the greatest inventions of mankind; as well known, general lighting fixtures can be usually installed inside and outside of a building or be portable for use; moreover, they can be turned on or off easily by users upon actual requirements while being connected to an appropriate power source and configured with corresponding circuit switches.

Most government departments prefer to arrange streetlights on both sides of roads or public areas like a park in order to improve the safety of driving or walking at night; furthermore, lighting fixtures like streetlights are mostly arranged in remote locations and widely distributed; therefore, controlling circuits for turning on or off the streetlights automatically may usually be further arranged to improve the convenience of operating the streetlights.

The automatic controlling circuits employed for such streetlights are usually set to a control mode in which the streetlights are turned on or off automatically at regular time or a control mode in which the streetlights are turned on or off automatically based on the ambient light condition; in addition, in order to achieve better availability rate, all the streetlights are mostly configured with parallel connection so that when part of the streetlights break down and cannot operate regularly, other streetlights can still provide part of illumination effect.

The above conventional controlling mode of streetlights might achieve the expected controlling effect of automatically turning on or off the streetlights, but cannot actually manage the operation state of each streetlight; especially, general streetlights are widely distributed and mostly located far away from the managing unit, therefore, relative managing staff cannot check each streetlight one by one at all to determine whether it is in regular operation as scheduled; instead, until the managing unit is passively informed by the road users who find out, they can find out the streetlights not turning on as expected or broken down; thus there exists a crisis that indirectly causes incidents to road users.

### SUMMARY OF THE INVENTION

The present invention is directed to provide a light fixture remote controlling system that receives the operation information of the light fixture through a wireless transmission mode, or transmits control signals to a light fixture.

To this end, the light fixture remote controlling system of the present invention includes a remote host and at least one light fixture; the remote host has a monitoring software built therein and is electrically connected with a first wireless transmitting/receiving module and a first power amplifying module for amplifying a signal wave transmitted outward by the first wireless transmitting/receiving module; each light fixture is provided in the body thereof with an AC-DC converter for a connection with a power source, a photoelectric module, and a controlling circuit electrically connected between the AC-DC converter and the photoelectric module, respectively; wherein the controlling circuit of each light fixture is further integrated with: a dimming module electrically connected with the photoelectric module for controlling a voltage/current output to the photoelectric module; a current/voltage stabilizing module electrically connected between the AC-DC converter and the dimming module for providing a stabilized output voltage/current for the photoelectric module; a second wireless transmitting/receiving module electrically connected with the AC-DC converter for performing signal transmission/reception with the first wireless transmitting/receiving module the remote host; a current/voltage detecting module electrically connected between the second wireless transmitting/receiving module and the current/voltage stabilizing module for detecting the voltage/current information output to the photoelectric module, and the detected voltage/current information is transmitted outward by the second wireless transmitting/receiving module; a second power amplifying module electrically connected with the second wireless transmitting/receiving module for amplifying a signal wave transmitted outward by the second wireless transmitting/receiving module to obtain a required transmission distance; a signal processing module electrically connected between the second wireless transmitting/receiving module and the dimming module for determining and executing a signal received by the second transmitting/receiving module.

With the above technical features, when the light fixture remote controlling system of the present invention is in use, each light fixture is connected with an external power source through the AC-DC converter so that a power required for operating the photoelectric module and the controlling circuit is provided from the AC-DC converter 22 and after the photoelectric module is in operation, a predetermined lighting effect can be achieved from the photoelectric module and the current/voltage detecting module regularly detects the voltage/current information output to the photoelectric module and the detected voltage/current information is transmitted outward by the second wireless transmitting/receiving module; then the first wireless transmitting/receiving module of the remote host receives the signal transmitted by each light fixture; the monitoring software of the remote host, based on the received voltage/current information, can obtain the on/off state of the photoelectric module of each light fixture and determine whether the photoelectric module of each light fixture is operated normally and further calculate the operation hours of the photoelectric module of each light fixture; moreover, the remote host can transmit relative control signals to the predetermined light fixture and achieve the purpose of managing the operation state of each light fixture and controlling the operation of each light fixture.

According to the above technical features, each light fixture further has a lightning strike protection module electrically connected to the front end of the AC-DC converter which is connected with an external power source through the lightning strike protection module.

The lightning strike protection module has a discharge prevention assembly built therein for discharging a strong current produced by the forward lightning strike.

Whether or not each light fixture is provided with a lightning strike protection module, the dimming module has a transistor built therein for controlling the magnitude of input voltage/current.

Whether or not each light fixture is provided with a lightning strike protection module, the dimming module has a variable resistor built therein for controlling the magnitude of input voltage/current.

Whether or not each light fixture is provided with a lightning strike protection module, the current/voltage stabilizing module has an OVP voltage stabilizing loop and an OVP current stabilizing loop built therein.

Whether or not each light fixture is provided with a lightning strike protection module, the current/voltage stabilizing module has an OVP voltage stabilizing loop, an OVP current stabilizing loop and a PFC power compensation loop built therein.

Whether or not each light fixture is provided with a lightning strike protection module, the current/voltage stabilizing module has an OVP voltage stabilizing loop, an OVP current stabilizing loop and an OHP over-temperature protection loop built therein.

Whether or not each light fixture is provided with a lightning strike protection module, the current/voltage stabilizing module has an OVP voltage stabilizing loop, an OVP current stabilizing loop, a PFC power compensation loop and an OHP over-temperature protection loop built therein.

The first wireless transmitting/receiving module of the remote host and the second wireless transmitting/receiving module of each light fixture each have an IEEE interface built therein.

The first power amplifying module of the remote host and the second power amplifying module of each light fixture each have an amplifier built therein.

Specifically, the following effects can be achieved by the present invention.

1. The operation state of each light fixture can be managed in a relatively more active manner.

2. The normal operation of each light fixture can be maintained in a relatively more active manner.

3. The remote host can further calculate the operation information of each light fixture.

4. The remote host can control each fixture's turning on, off or dimming and achieves the purpose of controlling the operation of the light fixture remotely.

### BRIEF DESCRIPTION OF THE DRAWINGS

FIG. 1 is the configuration reference diagram of a light fixture remote controlling system of the present invention;

FIG. 2 is a block diagram showing the basic configuration of a light fixture remote controlling system of a first embodiment of the present invention;

FIG. 3 is the configuration reference diagram of a controlling circuit of each light fixture; and

FIG. 4 is a block diagram showing the basic configuration of a light fixture remote controlling system of a second embodiment of the present invention.

### DETAILED DESCRIPTION OF THE PREFERRED EMBODIMENTS

The features of the present invention can be explicitly illustrated with reference to the drawings and description of the embodiments.

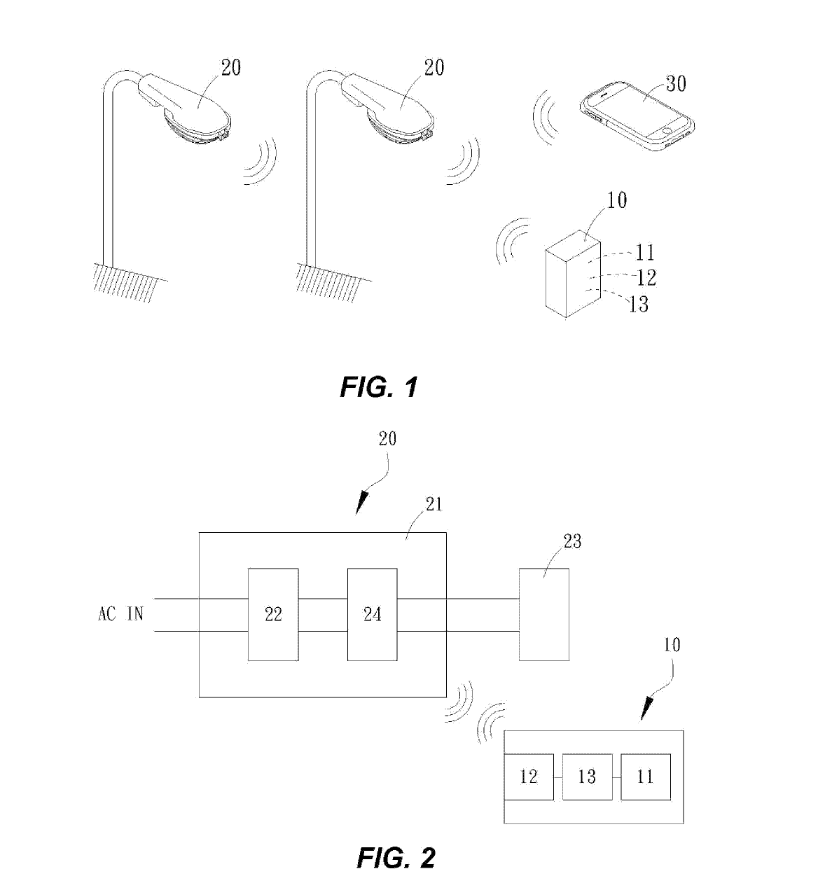

As shown in FIG. 1 which is the configuration reference diagram of a light fixture remote controlling system of the present invention, the present invention mainly provides a light fixture remote controlling system in which a remote host 10 manages the operation state of each light fixture 20 through a wireless transmission mode and further controls the operation of each light fixture 20; the integrated light fixture remote controlling system includes a remote host 10 and at least one light fixture 20; the remote host 10 has a monitoring software 11 built therein and is electrically connected with a first wireless transmitting/receiving module 12 and a first power amplifying module 13 for amplifying a signal wave transmitted outward by the first wireless transmitting/receiving module 12; in practice, the first wireless transmitting/receiving module 12 has an IEEE interface built therein, and the first power amplifying module 13 has an amplifier built therein for amplifying a signal to be transmitted to the first wireless transmitting/receiving module 12.

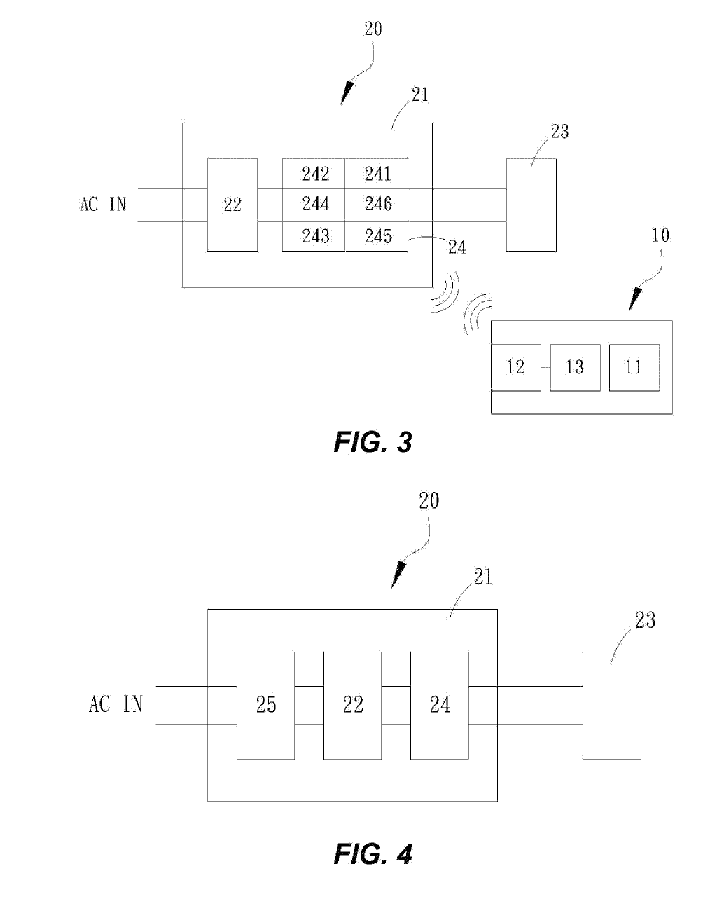

Referring to FIG. 2 which is a block diagram showing the basic configuration of a light fixture remote controlling system of the first embodiment of the present invention and FIG. 3 which is the configuration reference diagram of a controlling circuit of each light fixture in the present invention, each light fixture 20 of the present invention is provided in the body 21 thereof with an AC-DC converter 22 for a connection with a power source, a photoelectric module 23, and a controlling circuit 24 electrically connected between the AC-DC converter 22 and the photoelectric module 23, respectively; wherein the controlling circuit 24 of each light fixture is further integrated with:

a dimming module 241 which is electrically connected with the photoelectric module 23 and substantially can employ a transistor for controlling the magnitude of input voltage/current or have a variable resistor built therein for controlling the magnitude of input voltage/current to control the voltage/current output to the photoelectric module 23 so that the photoelectric module 23 produces a dimming function with different luminance.

a current/voltage stabilizing module 242 electrically connected between the AC-DC converter 22 and the dimming module 241; it substantially has an OVP voltage stabilizing loop and an OVP current stabilizing loop built therein for providing a stabilized output voltage/current for the photoelectric module; in practice, the current/voltage stabilizing module 242 can further have a PFC power compensation loop or an OHP over-temperature protection loop built therein, or further have a PFC power compensation loop and an OHP over-temperature protection loop built therein so as to provide a stabilized power supply for the photoelectric module 23.

a second wireless transmitting/receiving module 243 electrically connected with the AC-DC converter 22 for performing signal transmission/reception with at least one corresponding external remote host 10; in practice, the second wireless transmitting/receiving module 243 has an IEEE interface built therein for performing signal transmission/reception with the corresponding external remote host 10.

a current/voltage detecting module 244 electrically connected between the second wireless transmitting/receiving module 243 and the current/voltage stabilizing module 242 for detecting the voltage/current information output to the photoelectric module 23, and the detected voltage/current information is transmitted outward by the second wireless transmitting/receiving module 243;

a second power amplifying module 245 electrically connected with the second wireless transmitting/receiving module 243 for amplifying a signal wave transmitted outward by the second wireless transmitting/receiving module 243; in practice, the second power amplifying module 245 has an amplifier built therein for amplifying a signal to be transmitted to the second wireless transmitting/receiving module 243 to obtain a required transmission distance.

a signal processing module 246 electrically connected between the second wireless transmitting/receiving module 243 and the dimming module 241 for determining and executing a signal received by the second transmitting/receiving module 243.

In general, when the light fixture remote controlling system of the present invention is in use, the photoelectric module 23 of each light fixture 20 can be electrically connected with predetermined amount of light emitting diodes, fluorescent tubes or mercury lamps; when in use, each light fixture 20 is connected with an external power source through the AC-DC converter 22 so that a power required for operating the photoelectric module 23 and the controlling circuit 24 is provided from the AC-DC converter 22 and after the photoelectric module 23 is in operation, a predetermined lighting effect can be achieved from the photoelectric module 23.

In addition, the current/voltage detecting module 244 of each light fixture 20 regularly detects the voltage/current information output to the photoelectric module 23 and the detected voltage/current information is transmitted outward by the second wireless transmitting/receiving module 243; then the first wireless transmitting/receiving module 12 of the remote host 10 receives the signal transmitted by each light fixture 20; the monitoring software 11 of the remote host 10, based on the received voltage/current information, can obtain the on/off state of the photoelectric module 23 of each light fixture 20 and determine whether the photoelectric module 23 of each light fixture 20 is operated narmally and further calculate the operation hours of the photoelectric module 23 of each light fixture 20; moreover, the remote host 10 can transmit relative control signals to the predetermined light fixture 20 and achieve the purpose of managing the operation state of each light fixture 20 and controlling the operation of each light fixture 20.

Especially, the remote host 10 can be a web server host 10 and connected with a smart mobile phone 30 of the managing staff through the Internet; the managing staff can use the smart mobile phone 30 at hand or other devices with the Internet function to login the monitoring software 11 of the remote host 10 so as to manage the operation state of each light fixture 20 in real time and control the operation of each light fixture 20 in real time.

Furthermore, the light fixture of the present invention may be located in open places, so the light fixture of the present invention, as shown in FIG. 4, can be further electrically connected with a lightning strike protection module 25 in front of the

AC-DC converter 22, and connected with an external power source through the lightning strike protection module 25; in practice, the lightning strike protection module 25 can have a discharge prevention assembly built therein for discharging a strong current produced by the forward lightning strike; so that when struck by lightning, the light fixtures can be protected against the damage caused by the lightning by conducting the strong current to the ground to effectively absorb the same.

Compared with the prior arts, the light fixture remote controlling system can not only manage the operation states of each light fixture in a relatively more active manner and maintain the normal operations of each light fixture in a relatively more active manner, but also the remote host can further calculate the operation information of each light fixture and control each fixture's turning on, off or dimming and achieves the purpose of controlling the operation of the light fixture remotely.

In sum, the present invention is to provide a light fixture monitoring system to seek a patent protection. While the present invention has been shown and described with respect to the embodiments, it will be understood by those skilled in the art that various changes and modifications may be made without departing from the scope of the invention as defined in the following claims. Accordingly, there is no intention to limit the invention to the specific forms disclosed, but on the contrary, the invention is to cover all modifications, alternate constructions and equivalents falling within the spirit and scope of the invention as expressed in the appended claims.

What is claimed is:

1. A light fixture remote controlling system comprising a remote host and at least one light fixture; the remote host having a monitoring software built therein and electrically connected with a first wireless transmitting/receiving module and a first power amplifying module for amplifying a signal wave transmitted outward by the first wireless transmitting/receiving module; each light fixture is provided in the body thereof with an AC-DC converter for a connection with a power source, a photoelectric module, and a controlling circuit electrically connected between the AC-DC converter and the photoelectric module, respectively; wherein the controlling circuit of each light fixture is further integrated with:
a dimming module electrically connected with the photoelectric module for controlling a voltage/current output to the photoelectric module;
a current/voltage stabilizing module electrically connected between the AC-DC converter and the dimming module for providing a stabilized output voltage/current for the photoelectric module;
a second wireless transmitting/receiving module electrically connected with the AC-DC converter for performing signal transmission/reception with at least one corresponding external remote host;
a current/voltage detecting module electrically connected between the second wireless transmitting/receiving module and the current/voltage stabilizing module for detecting the voltage/current information output to the photoelectric module, and the detected voltage/current information is transmitted outward by the second wireless transmitting/receiving module;
a second power amplifying module electrically connected with the second wireless transmitting/receiving module for amplifying a signal wave transmitted outward by the second wireless transmitting/receiving module to obtain a required transmission distance;
a signal processing module electrically connected between the second wireless transmitting/receiving module and the dimming module for determining and executing a signal received by the second transmitting/receiving module.

2. The light fixture remote controlling system according to claim 1, wherein each light fixture has a lightning strike protection module electrically connected to the front end of the AC-DC converter which is connected with an external power source through the lightning strike protection module.

3. The light fixture remote controlling system according to claim 2, wherein the lightning strike protection module has a discharge prevention assembly built therein for discharging a strong current produced by the forward lightning strike.

4. The light fixture remote controlling system according to claim 1, wherein the dimming module of each light fixture has a transistor built therein for controlling the magnitude of input voltage/current.

5. The light fixture remote controlling system according to claim 1, wherein the dimming module of each light fixture has a variable resistor built therein for controlling the magnitude of input voltage/current.

6. The light fixture remote controlling system according to claim 1, wherein the current/voltage stabilizing module of each light fixture has an OVP voltage stabilizing loop and an OVP current stabilizing loop built therein.

7. The light fixture remote controlling system according to claim 1, wherein the current/voltage stabilizing module of each light fixture has an OVP voltage stabilizing loop, an OVP current stabilizing loop and a PFC power compensation loop built therein.

8. The light fixture remote controlling system according to claim 1, wherein the current/voltage stabilizing module of each light fixture has an OVP voltage stabilizing loop, an OVP current stabilizing loop and an OHP over-temperature protection loop built therein.

9. The light fixture remote controlling system according to claim 1, wherein the current/voltage stabilizing module of each light fixture has an OVP voltage stabilizing loop, an OVP current stabilizing loop, a PFC power compensation loop and an OHP over-temperature protection loop built therein.

10. The light fixture remote controlling system according to claim 1, wherein the first wireless transmitting/receiving module of the remote host and the second wireless transmitting/receiving module of each light fixture each have an IEEE interface built therein.

11. The light fixture remote controlling system according to claim 1, wherein the first power amplifying module of the remote host and the second power amplifying module of each light fixture each have an amplifier built therein.

12. The light fixture remote controlling system according to claim 2, wherein the dimming module of each light fixture has a transistor built therein for controlling the magnitude of input voltage/current.

13. The light fixture remote controlling system according to claim 2, wherein the dimming module of each light fixture has a variable resistor built therein for controlling the magnitude of input voltage/current.

14. The light fixture remote controlling system according to claim 2, wherein the current/voltage stabilizing module of each light fixture has an OVP voltage stabilizing loop and an OVP current stabilizing loop built therein.

15. The light fixture remote controlling system according to claim 2, wherein the current/voltage stabilizing module of each light fixture has an OVP voltage stabilizing loop, an OVP current stabilizing loop and a PFC power compensation loop built therein.

16. The light fixture remote controlling system according to claim 2, wherein the current/voltage stabilizing module of each light fixture has an OVP voltage stabilizing loop, an OVP current stabilizing loop and an OHP over-temperature protection loop built therein.

17. The light fixture remote controlling system according to claim 2, wherein the current/voltage stabilizing module of each light fixture has an OVP voltage stabilizing loop, an OVP current stabilizing loop, a PFC power compensation loop and an OHP over-temperature protection loop built therein.

18. The light fixture remote controlling system according to claim 2, wherein the first wireless transmitting/receiving module of the remote host and the second wireless transmitting/receiving module of each light fixture each have an IEEE interface built therein.

19. The light fixture remote controlling system according to claim 2, wherein the first power amplifying module of the remote host and the second power amplifying module of each light fixture each have an amplifier built therein.
